(19) United States
(12) Patent Application Publication
(10) Pub. No.: US 2025/0379609 A1
(43) Pub. Date: Dec. 11, 2025

(54) A METHOD OF CONTROLLING COMMUNICATION OF DATA PACKETS OF A COMMUNICATION DEVICE AND A COMMUNICATION DEVICE

(71) Applicant: SIGNIFY HOLDING B.V., EINDHOVEN (NL)

(72) Inventors: JUN YAO, SHANGHAI (CN); BOFENG LI, SHANGHAI (CN); CHANGHE LI, SHANGHAI (CN); PEILIANG DONG, SHANGHAI (CN)

(21) Appl. No.: 18/876,705

(22) PCT Filed: Jun. 19, 2023
(86) PCT No.: PCT/EP2023/066389

§ 371 Date: Dec. 19, 2024

(30) Foreign Application Priority Data
Jun. 22, 2022 (WO) PCT/CN2022/100566
Aug. 26, 2022 (EP) 22192417.8

(51) Int. Cl. H04B 1/401; H04B 1/00; H04B 1/18; H04L 69/18

(52) U.S. Cl. CPC H04B 1/401; H04B 1/005; H04B 1/18; H04L 69/18

(57) ABSTRACT

A method of controlling communication of data packets of a communication device supporting at least a first communication protocol and a second communication protocol, the communication device comprising a control module, a first antenna module and a second antenna module respectively and communicatively connected to the control module, wherein the first antenna module is configured to receive and/or transmit data packets, and the second antenna module is configured to receive data packets only. The method is performed by the control module and comprises the steps of: controlling the first antenna module to operate according to the first communication protocol and the second communication protocol alternately by switching the first antenna module between operating according to the first communication protocol and operating according to the second communication protocol, and controlling the second antenna module to operate according to one of the first and second communication protocols while the first antenna module operates according to the other of the first and second communication protocols.

### TECHNICAL FIELD

The present disclosure generally relates to the field of network communication, more particularly, to a method of controlling communication of data packets of a communication device and a communication device.

### BACKGROUND

The rapid development of Internet of Things, IoT, network allows more and more electronic devices to get access to network connection. For enabling network connection to electronic devices, device developers are faced with a plurality of choices from different wireless interfaces and corresponding communication protocols each having different characteristics.

EP2258125A1 relates to dynamic assignment of home link address and prefix designators for networks that employ Mobile Internet Protocol (MIP). It discloses that a MIMO system employs multiple (NT) transmit antennas and multiple (NR) receive antennas for data transmission. Multiple access wireless communication system 900 includes multiple cells. Each cell includes a Node B that includes multiple sectors. The multiple sectors can be formed by groups of antennas with each antenna responsible for communication with UEs in a portion of the cell.

As an example, WiFi allows high-speed video or data transmission, 802.15.4 with Zigbee or Thread is known for being suitable for low-power sensors, while Bluetooth® support excellent point-to-point communication for audio or file transfers. Traditionally, devices operating according different communication protocols could not interoperate, which posed much frustration for end users as it prevents them from fully enjoying the promise of a seamlessly interactive devices.

The introduction of the so-called combo chips supporting multiple communication protocols simultaneously with a single chip provides a good solution to the above problem. A combo chip enables a communication device to support multiple communication protocols and allows developers to focus on their application instead of inter-platform communication, thereby simplifying development and accelerating device time to market. End users, for their part, get simplified setup and seamless control of their smart devices.

In its operation, a communication device comprising a combo chip can communicate with other communication devices according to a plurality of communication protocols supported by the combo chip. A same antenna may be arranged to communicate data of two different communication protocols having a same band, such as ZigBee and the Bluetooth protocols. In this case, communication according to for example two communication protocols is performed in a time sharing manner, that is, the device dynamically switch between a Zigbee mode and a Bluetooth mode in a time sharing manner, alternatively communicating Zigbee data and Bluetooth data.

The antenna of the communication device is connected to a combo chip via a common radio peripheral system including radio frequency, RF, front end and radio controls. By way of a radio controller, a radio scheduler or a radio manager, the radio part of the communication device switches between Bluetooth and Zigbee, allowing Bluetooth stacks and ZigBee stacks to run simultaneously on the same radio.

However, dynamic switch of ZigBee stacks and Bluetooth stacks may causes some packet loss during the communication. As a result, some IoT communication device may not act according to a communicated command as expected, which will cause bad user experience.

Therefore, there is a genuine need of a method and a communication device for preventing packet loss that occurs when the communication device switching between different communication protocols supported by a combo chip comprised by the communication device.

### SUMMARY

In a first aspect of the present disclosure, there is presented a method of controlling communication of data packets of a communication device supporting at least a first communication protocol and a second communication protocol, the communication device comprising a control module, a first antenna module and a second antenna module respectively and communicatively connected to the control module, wherein the first antenna module is configured to receive and/or transmit data packets, and the second antenna module is configured to receive data packets only, the method performed by the control module and comprising the steps of:
controlling the first antenna module to operate according to the first communication protocol and the second communication protocol alternately by switching the first antenna module between operating according to the first communication protocol and operating according to the second communication protocol, and
controlling the second antenna module to operate according to one of the first and second communication protocols while the first antenna module.

The present disclosure is based on the insight data packets loss that occurs to a communication device, employing a combo chip supporting at least two communication protocols, as a result of switch a single first antenna module of the communication device between the first communication protocol and the second communication protocol can be effectively prevented by employing a second or slave antenna module to supplement the single first antenna module.

The second or slave antenna module is deployed to be connected to a control module, which is normally a software module running on the combo chipset, to construct an auxiliary receive channel separate from a main communication channel provided by the first antenna module.

Based on the solution of the present disclosure, while the first antenna module is dynamically switched between the first communication protocol and the second communication protocol, the auxiliary receive channel provided by the second antenna module starts to work to detect and receive data packets of a communication protocol that is currently not received by the first antenna module.

In a sense, the first antenna module and the second antenna module operate alternatively and supplementarily to communicate data packets of the first and second communication protocols. At any time, data packets of each one of the communication protocols is either received by the first antenna module or received by the second antenna module. It thereby effectively receives and retain data packets of both communication protocols, achieving zero packet loss in the combo network.

Any potential packet loss that may happen is thereby prevented as data packets of the communication protocol which is now not received by the first antenna module are securely retained by the second antenna module.

Such a solution according to the present disclosure does not involve complicated hardware modification or addition to the communication device, as both the first antenna module and the second antenna module may share a same radio system. Therefore, adding a receive only antenna enables the nearly zero packet loss with limited cost and without any wireless interference of radios.

According to present disclosure, the first antenna module is configured to receive and/or transmit data packets, and the second antenna module is configured to receive data packets only.

As the second antenna module is configured to receive data packets only, only an auxiliary receiving channel needs to be designed for the second antenna module, which helps to keep the hardware structure of the communication device simple while meeting the requirement of keeping data packets of both the first and the second communication protocols completely and fully received by the communication device.

In an example of the present disclosure, the first control step comprises:
switching the first antenna module between the first communication protocol and the second communication protocol according to a switching principle.

The switching between the first communication protocol and the second communication protocol is performed according to a switching principle. The switching principle is described herein as referring to the way of controlling the switching between the communication protocols, in terms of for example frequency of switching, conditions of switching, sharing of radio resources, and so on.

It will be elaborated that the switching principle may be configured as needed and may combine a fixed or flexible time scheme, which allows different requirements from the user to be catered.

In an example of the present disclosure, the communication device further comprises a first task scheduler arranged to control data communication by the first antenna module and a second task scheduler arranged to control data receiving by the second antenna module, the second control step comprises:
transmitting a current status of a protocol stack of the one of the first and second communication protocols currently operated by the first antenna module received form the first task scheduler to the second task scheduler, and
controlling the second task scheduler to operate a protocol stack the other one of first and second communication protocols.

As the control module does not interact with protocol stacks of the first and second communication protocols directly, the switching is in practice realized by the control module informing the second task scheduler about the protocol stack that the first task scheduler currently operates, allowing the second task scheduler to switch to operate the protocol stack not operated by the first task scheduler.

In connection with the switching principle above, in practice the first task scheduler takes control of the switching principle between the protocol stacks. This is how the main processor of the communication device operates and does not require extra software updates to general operating principles of the main processor.

In an example of the present disclosure, the controlling step comprises:
switching the first antenna module between the first communication protocol and the second communication protocol periodically.

Switching of the first antenna module between the first and second communication protocols may be performed according to a fixed time schedule. That is, the first antenna module is configured to operate according to the first communication protocol for example for a first time period and then to operate according to the second communication protocol for a second time period.

It is noted that while the first antenna module switches between the first and second communication protocols the second antenna module also switches between the first and second communication protocols, in an opposite manner.

The time period may be configured depending on applications of the communication device which runs based on the first and second communication protocols, allowing different applications to operate according to the supported communication protocols in a way that suits the applications best.

In an example of the present disclosure, the method further comprising the step of:
switching the first antenna module to operate according to the communication protocol of received data packets by the second antenna module if the second antenna module receives data packets while the first antenna module is idle.

It is likely that no data packets is presently received by the first antenna module, in this case, when data packets are received by the second antenna module, the first antenna module may be switched to operate according to the communication protocol of received data packets by the second antenna module immediately. This is especially beneficially when the first antenna module is configured to operate according to one communication protocol significantly longer than according to the other communication protocol. Overall efficiency of data communication of the communication device is thereby improved.

In an example of the present disclosure, the switching step comprises:
receiving an indication representing a priority of the data packets received by the second antenna module, and
determining to switch the first antenna module to operate according to the communication protocol of received data packets based on the priority of the data packets received by the second antenna module.

This allows switching of the communication device between the first and second communication protocols to be performed according to a flexible time schedule. Specifically, when data packets are received via the second antenna module and it is determined that this data has a higher priority and a protocol stack corresponding to the communication protocol currently processed by the first antenna module is idling, the control module will switch the first antenna module to operate according to the communication protocol of received data packets, allowing the received data packets to be processed immediately.

In an example of the present disclosure, the communication device comprises a data buffer, wherein data packets received by the second antenna module are stored in a data buffer, the method further comprising, subsequent to the switching step, the steps of:
retrieving data packets from the data buffer, and
processing the data packets.

The data packets received by the second antenna module are thereby processed and any required subsequent action or operation of the communication device may be performed accordingly, preventing a user of the communication device from experiencing any degraded service.

In an example of the present disclosure, wherein the first communication protocol comprises ZigBee and the second communication protocol comprises Bluetooth, or vice versa.

An IoT device very often operates according to both the Zigbee and the Bluetooth protocols simultaneously. The method as described can be advantageously used to such a device.

A second aspect of the present disclosure provides a communication device configured to have its communication of data packets controlled according to the first aspect of the present disclosure, the communication device supporting at least a first communication protocol and a second communication protocol, the communication device comprising a control module, a first antenna module and a second antenna module respectively and communicatively connected to the control module, wherein the first antenna module is configured to receive and/or transmit data packets, and the second antenna module is configured to receive data packets only,
wherein the control module is configured to:
control the first antenna module to operate according to the first communication protocol and the second communication protocol alternately by switching the first antenna module between operating according to the first communication protocol and operating according to the second communication protocol, and
control the second antenna module to operate according to one of the first and second communication protocols while the first antenna module operates according to the other of the first and second communication protocols.

Data communication of such a communication device is controlled by using the second antenna module supplementing the first antenna module, achieve beneficial advantages as described above with reference to the first aspect of the present disclosure.

In an example of the present disclosure, the control module is configured to:
switch the first antenna module between the first communication protocol and the second communication protocol periodically, or
switching the first antenna module to operate according to the communication protocol of received data packets by the second antenna module if the second antenna module receives data packets while the first antenna module is idle.

The communication device can switch between the first and second communication protocols according to a fixed or flexible schedule. In either cases, packet loss that may happen as a result of the switching is prevented, rendering improved user experience.

In an example of the present disclosure, the communication device comprises a data buffer, wherein data packets received by the second antenna module are stored in the data buffer, the control module is further configured to:
retrieve data packets from the data buffer, and
process the data packets.

The data packets that could have lost is retained by the second antenna module and then get processed in a timely manner, allowing the communication device to operate according to all instructions and commands communicated to the communication device.

In an example of the present disclosure, the first communication protocol comprises ZigBee and the second communication protocol comprises Bluetooth, or vice versa.

A third aspect of the present disclosure provides a computer program product, comprising a computer readable storage medium storing instructions which, when executed on at least one processor, cause said at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 is a block diagram schematically illustrating a communication device for controlling communication of data packets in accordance with the present disclosure.

FIG. 2 schematically illustrates an exemplary operating scheme of the first antenna module and the second antenna module in accordance with the present disclosure.

FIG. 3 schematically illustrates, in a system view, a diagram of control of data packet communication of the communication device of FIG. 1.

FIG. 4 schematically illustrates, in a flow chart type diagram, an embodiment of a method of controlling of the communication of data packets, according to the present disclosure.

FIG. 5 schematically illustrates an alternative embodiment the embodiment of FIG. 4.

FIG. 6 schematically illustrates, in a protocol diagram, an embodiment of a method of controlling of the communication of data packets, according to the present disclosure.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

The inventive concept of the present disclosure will be described with reference to an exemplary network comprising communication devices configured to operate according to both Bluetooth and ZigBee protocols simultaneously by way of a combo chipset supporting both protocols and a single antenna configured for communicating data of both protocols. However, it will be understood by a skilled person that the principle described herein applies also to other combo networks in which communication devices comprise a single chip supporting two or more communication protocols with a single antenna.

An antenna module as used herein may be configured to comprise suitable hardware, logic, circuitry, and/or code that may be adapted to communicate data packets of one or more communication protocols. The antenna module may therefore be construed as comprising an antenna and relevant intelligent controlling means, a radio front end module arranged for preliminary processing of signals received by the antenna, a radio frequency, RF, transceiver module arranged to process RF signals to be transmitted and/or received by the antenna, and a baseband module arranged for processing base band signals to be passed to or received from the RF transceiver.

In this sense, an antenna module operating according to a communication protocol is to be understood as an antenna of the antenna module receiving and transmitting signals comprising data packets of the communication protocol.

For a combo network, each communication device or terminal device operate according to or switch between two (or more) communication protocols by using a combo chip, also known as a processor or a microcontroller. The processor supports the two communication protocols designed for a same frequency band such as ZigBee protocol and Bluetooth Protocol.

Each communication device comprises an antenna module which is communicatively connected to the processor and utilized for transmission and reception of for example two communication protocols which are supported by the processor. The antenna module may comprise suitable hardware that may be adapted to provide transmission and reception of for example Bluetooth and ZigBee communication.

When a communication device dynamically switches between a Zigbee stack and a Bluetooth stack, some data packets may get lost during the communication. As a result, the device would not act in accordance with commands or instructions transmitted via the lost data packets, which will cause bad user experience.

For the purpose of preventing packet loss for communication devices in the combo network, the present disclosure proposes to employ a second or slave antenna to complement the main antenna used for data communication.

According to the present disclosure, a communication device supporting two or more communication protocols by way of a combo chip, supporting the two or more communication protocols and a single first antenna is provided with a second antenna. Both the first antenna and the second antenna are connected to a same RF transceiver which is arranged to control signals transmission and reception by the first and second antennas.

Data received by both the first and second antennas are processed by the RF transceiver, for example by a readily available RF transceiver chip. The received and processed data is then send to a main processor, which is the combo chip, of the communication device.

The RF transceiver is controlled by the main processor, for example by way of configuration data written to a register of the RF transceiver chip, to switch between the first and second protocols, allowing the first and second antennas to receive data of the first and second protocols.

Switching of the communication device between operating according to the first communication protocol and the second communication protocol is realized by switching between a first communication stack and a second communication stack by way of scheduling of an operating system of the communication device. Such switching is beyond the scope of the present disclosure and will not be described in detail herein.

The present disclosure thereby proposes a communication device operating to switch between two communication protocols which utilizes a first and a second antenna to prevent possible packets loss of one of the communication protocols, caused for example by the device operating overlong according to one protocol.

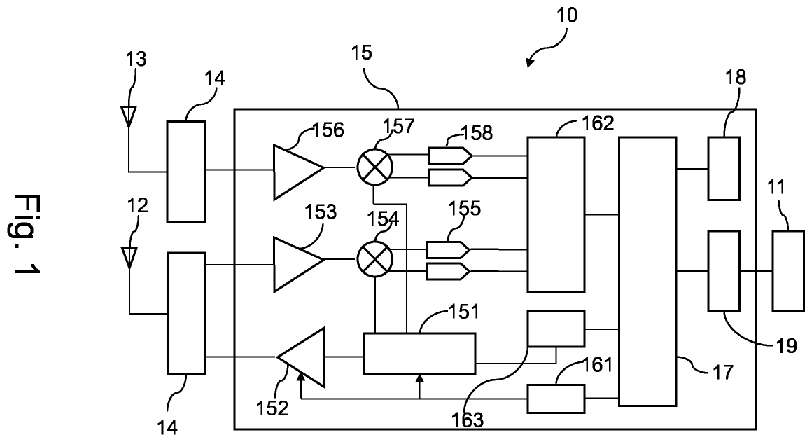

FIG. 1 is a block diagram schematically illustrating a communication device 10 for controlling communication of data packets in accordance with the present disclosure. The communication device 10 comprises a combo chip or processor 11 supporting at least two communication protocols and a first or main or master antenna module and a second or slave antenna module.

Two or more of the supported communication protocols are designed for a same frequency band, and both the first antenna module and the second antenna module operate in the frequency band.

The communication device may comprise other antennas operating in other frequency bands supported by the communication device. This is outside the scope of the subject matter of the present disclosure and will not be described here.

The first antenna module is shown to comprise a first antennas 12 and an exemplary baluns and filter module 14 and radio and baseband module 15. The second antenna module is shown to comprise a second antenna 13 and a baluns and filter modules 14 and the radio and baseband module 15.

It will be understood by those skilled in the art the radio and baseband module 15 is described for illustrative purpose only and the present disclosure is not limited to the described structure and configuration. The radio and baseband module 15 may be configured to comprise suitable logic, circuitry, and/or code that may be adapted to process data packets of communication protocols supported by the processor 11.

The first antenna 12 and the second antenna 13 are connected, via respective baluns and filter modules 14 to the radio and baseband module 15, thereby connecting the antennas 12 and 13 to the processor 11.

The radio and baseband module 15 comprises a radio transceiver comprising a frequency synthesizer 151 and a power amplifier 152 for the transmit branch and a low noise amplifier 153, a mixer 154 and analogue digital converters 155 for the receiving branch.

A separate receiving branch is also built for the second or slave antenna 13 by way of a low noise amplifier 156, a mixer 157 and analogue digital converters 158.

The radio and baseband module 15 also comprises a baseband module, comprising a modulator 161 for modulating baseband signals to RF signals and a demodulator 162 to demodulate signals processed by the receive branch to retrieve the baseband signal to be processed subsequently.

The radio and baseband module 15 is illustrated to comprise a control part 17 which is configured for processing data packets received or transmitted via the first and second antennas 12 and 13.

The control part 17 is connected to a storage device 18 comprised or communicatively connected to the radio and baseband module 15 and configured for storing data packets transmitted or received via the antennas 12 and 13.

An interface 19 enables the radio and baseband module 15 to be connected to the processor 11 supporting two or more communication protocols, two of the protocols can be handled via a single antenna, like the first and second antennas 12 and 13.

The above describes main components or parts of the communication device 10. It will be understood by those skilled in the art that those parts or blocks are described for illustrating and exemplary purpose only and the present disclosure is not limited to the described details. Instead, the described function blocks may be implemented in any suitable logic, circuitry, and/or code known to a skilled person for realizing the described functions.

It is seen from the above architecture overview that the first antenna module is configured to handle both data transmission and data receiving. The data to be transmitted are sent from the processor 11 through the interface 19 to the control part 17, which will call certain APIs for data transmission via the first antenna 12. The data are then processed through the modulator 161 and further handled by the frequency synthesizer 151. Thereafter the data are processed by the power amplifier 152 and are then ready for the first antenna 12 to send.

The automatic gain controller, AGC 163, controls the amplification factor according to input signal detection.

Moreover, both the first antenna 12 and the second antenna 13 are configured to receive data. The received data are thereafter processed by a low noise amplifiers 153, 156 and Analog-to-Digital Converter 155, 158 to get valid data. These data are processed by the demodulator 162 and fed to the control part 17. The control part can decide whether the data is from the first antenna 12 or second antenna 13. The data from the second antenna 13 are stored in the storage device 18 for further processing.

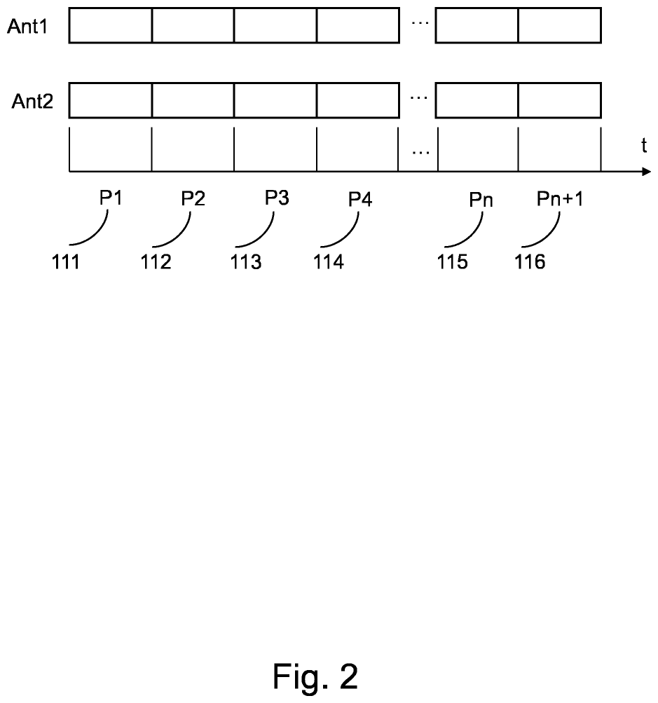

FIG. 2 schematically illustrates an exemplary operating scheme of the first antenna module and the second antenna module in accordance with the present disclosure. The first and second antenna modules are arranged to communicate signals in the frequency range of for example Bluetooth and Zigbee protocols.

The first antenna module Ant1 operates, under the control of an operating system or a control module of the communication device, to receive and transmit data packets of Bluetooth and Zigbee protocols in a time alternating manner. It is seen from FIG. 2 at a time period P1 111, the first antenna module Ant1 operates to receive and/or transmit Bluetooth data packets, at a next time period P2 112, the first antenna module Ant1 operates to receive and/or transmit Zigbee data packets. The first antenna module Ant1 switches back to receive and/or transmit Bluetooth data packets at a time period P3 113 . . . and so on.

In the meantime, the second antenna module Ant2 operates, under the control of the operating system or the control module of the communication device, to supplement the operation of first antenna module Ant1 and to detect and receive data packets of the protocol currently not handled by the first antenna module.

Referring to FIG. 2, at the time period P1 111, the second antenna module Ant2 operates to detect and receive Zigbee data packets, if any data packets of Zigbee protocol is detected. At the next time period P2 112, the second antenna module Ant2 operates to receive Bluetooth data packets. The second antenna module Ant2 switches back to receive Zigbee data packets at the time period P3 113 . . . and so on.

From the above it is seen that the communication device, specifically the first and second antenna modules, are controlled, in a first time period, such that data packets of a first communication protocol are communicated, that is, received and transmitted via the first antenna module while data packets of a second communication protocol are received by the second antenna module, if data packets of the second communication protocol are detected.

The protocol stacks and other relevant processing parts such as the baseband and transceiver parts are then switched such that in a second time period following the switching, data packets of the second communication protocol are communicated via the first antenna module while data packets of the first communication protocol are received by the second antenna, if data packets of the first communication protocol are detected.

From the perspective of the communication device, it operates according to the first communication protocol and the second communication protocol alternately in a time sharing manner. During any time period when data packets of the first communication protocol are communicated via the first antenna module, the second antenna module supplementarily monitors and receives any data packets of the second communication protocol, and vice versa. It thereby avoid any data packets of the first or second communication protocol from getting lost.

In the following, control of communication of data packet by the communication device 10 will be detailed from the system perspective.

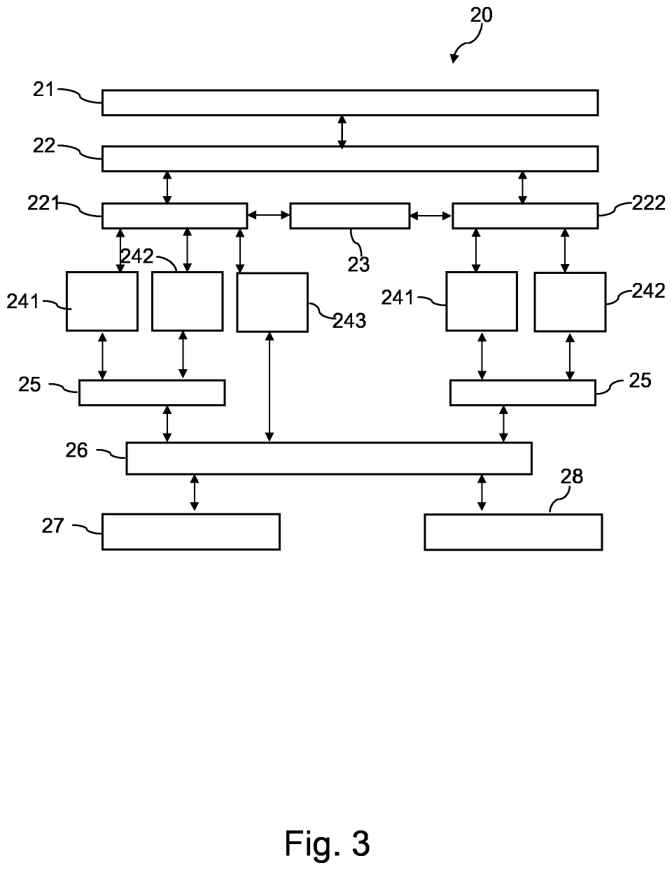

FIG. 3 schematically illustrates, in a system view, a diagram 20 of control of data packet communication of the communication device of FIG. 1.

From the system perspective of a communication device like the communication device of FIG. 1, an application software 21 handling the system functions works on top of a control module or an operating system, OS, 22 of the communication device.

The application software 21 may generate data to be communicated by the communication device 10 to other communication devices in the network or to a managing or server device located remotely. Besides, data or message received from other communication devices or the managing or server device are processed by the application software 21. Such data are exchanged between the application software 21 and the control module 22.

The control module or OS 22 undertakes message transmission among different tasks and schedules task operations for a Zigbee stack and a Bluetooth stack according to a program cycle and trigger events.

To implement the dual antenna module configuration as described above, the control module 22 controls a main task 221 configured to control data communication via the main or first antenna module and a receive, Rx, task 222 configured to control data receiving via the slave or second antenna module.

The main task 221 deals with message transmission and receiving of the first antenna module. The main task 221 can process for example Zigbee stack, Bluetooth stack or other wireless stacks and decide a switching principle between different protocol stacks.

The switching principle is described herein as referring to the way of controlling the switching between the communication protocols, in particular between different protocol stacks, in terms of for example frequency of switching, conditions of switching, sharing of radio resources, and so on.

The Rx task 222 handles Zigbee and Bluetooth message received by the slave antenna module. For simplicity, the Rx task 222 is configured to support only Zigbee and Bluetooth stacks but no other wireless stacks.

Both the main task 221 and the Rx task 222 have access to a storage device such as a data buffer 23 for storing received data. The storage device 23 may be internal to the processor of the communication device or communicatively connected to the communication device.

In the operation of the communication device supporting two or more protocols, switching between a first protocol such as ZigBee protocol and a second protocol such as Bluetooth protocol is generally viewed as switching between a ZigBee stack 241 and Bluetooth stack 242 processing data packets of each protocol, under control of the main task 221 and the Rx task 222.

Though the main task 221 and Rx task 222 are depicted to control separate ZigBee stack 241 and the Bluetooth stack 242 in FIG. 2, this is just for convenience purpose only, and a skilled person will understand that there is one protocol stack for each protocol.

In case that the processor of the communication device further supports other wireless protocols, message or data of those protocols are processed via other wireless stacks 243. This is outside the scope of the present disclosure and will not be discussed herein.

The switching principle and configuration data decided by the main task 221 and Rx task 222 are passed to a radio controller 25. The radio controller 25 controls the message routing for the Zigbee or Bluetooth stacks. In addition, if other wireless stacks are used, such as Wi-Fi protocol or proprietary protocols, the messages can bypass the radio controller 25 and be exchanged with other communication devices directly.

The radio controller 25 is configured to control the RF part of the communication device in coordination with Zigbee and Bluetooth stack, to route respective data packets via the hardware adaption layer 26 to either the first antenna 27 or the second antenna 28. The hardware adaption layer 26 contains the hardware drivers for using the first antenna 27.

For the second antenna 28, the radio controller 25 and the hardware adaption layer 26 have the same function as those for the first antenna 27. After messages are received via the second antenna 28, the Rx task 222 stores the messages in the data buffer 23.

The Rx task 222 then transmits an indication to the control module 22 indicating that messages are received by the slave antenna. The control module 22 will notify the main task 221 to retrieve the messages and have the same processed in the same way as messages received via the first antenna.

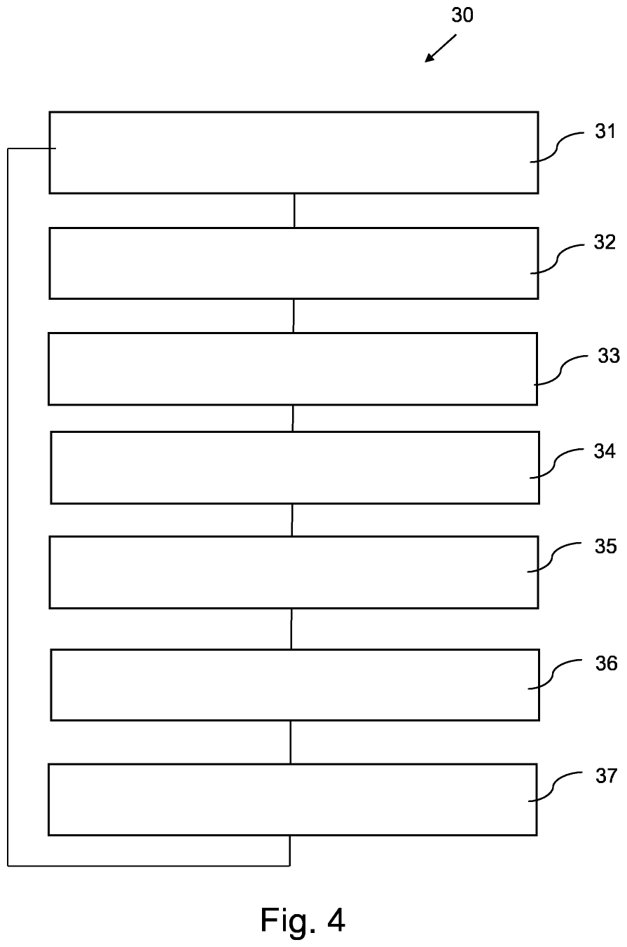

In the following, controlling of the communication of data packets by the communication device 10 is described with reference to FIG. 4, which schematically illustrates, in a flow chart type diagram, an embodiment of a method of controlling of the communication of data packets of the communication device, according to the present disclosure.

As preparatory steps, a combo network where all nodes support both Zigbee and Bluetooth protocols is formed. For each communication device, the Zigbee stack and the Bluetooth stack dynamically switch between each other to take over the system, thereby allowing the communication device to communicate data packet according to ZigBee protocol and Bluetooth protocol alternatively, or in a time divided manner.

It can be understood by those skilled in the art that the switch between the Zigbee stack and Bluetooth stack can be configured based on requirements of specific applications.

After the combo network is formed, each communication device starts to operate and switch between Zigbee and Bluetooth stacks according to a predefined schedule, such as the one illustrated in FIG. 2. That is, each communication device operates according to Zigbee protocol in a first time period and then switches to operate according to Bluetooth protocol in a second time period, and so on. The procedure is repeated over time.

A ratio between a first time period of the first protocol and a second time period of the second protocol may be configured by an application software and different software may configure the ratio differently.

In an example of the present disclosure, it is configured that the Zigbee stack occupies much more time than the Bluetooth stack. That means the combo network mainly works in the Zigbee mode.

It is discussed that the first antenna is configured to handle message transmission and receiving for both Zigbee and Bluetooth packets, while the second antenna is configured to only receive messages without transmission.

When switching between the Zigbee stack and the Bluetooth stack, the main task 221 will notify the Rx task 222 about a current stack status through the control module 22. Then the Rx task 222 will switch the stack accordingly.

At step 31, the communication device operates in the ZigBee mode and data packets of Zigbee protocol are communicated via the first antenna. In the meantime, the second antenna is used to monitor Bluetooth data packets.

If any valid Bluetooth packets in the operation channel are detected by the second antenna, at step 32, the Rx task will receive the Bluetooth packets, decoding the packets and store the data in the data buffer.

When Bluetooth packets are received, at step 33, an indication indicating that Bluetooth data have been received is transmitted from the Rx task to the main task through the control module. The Bluetooth data packets will be processed by the main task when the main task switches to operate the Bluetooth stack.

The communication device operates in the Zigbee for a specified period. When this time period expires, at step 34, the control module controls to switch between the Zigbee stack and the Bluetooth stack.

The switching is described as a procedural step to facilitate easy understanding of the present disclosure.

At step 35, the communication device operates in the Bluetooth mode and data packets of Bluetooth protocol are communicated via the first antenna. In the meantime, the second antenna is used to monitor Zigbee data packets in the operation channel.

In the same way, Zigbee packets received by the second antenna at step 36 are decoded and store in the data buffer. An indication is sent to the main task through the control module. So the Zigbee packets in the data buffer can be processed by the main task when the main task operates the Zigbee stack. This is not illustrated as a separate step in FIG. 4 for simplicity reasons.

At step 36, when the time period expire for operating the Bluetooth protocol expires, the control module controls to switch between the Zigbee stack and the Bluetooth stack again. The procedure then goes back to step 31 and the steps are repeated over time.

Each time when the switch between Zigbee and Bluetooth stack occurs, the data buffer will be cleaned.

The cycle period of Zigbee and Bluetooth are determined by the application software and can be configured as needed. Then the radio controller will route the packet sending and receiving for the Zigbee or Bluetooth stacks. Moreover, the proportion of Zigbee and Bluetooth in the working circle depends on the task type and can also be configured.

It can be contemplated by those skilled in the art that the above described procedure applies in the same way to the first antenna operating in the Bluetooth mode and the second antenna receives Zigbee packets and then switches to the Zigbee mode.

In the above procedure, the switching of the operation mode takes place when the first time period expires. The switching may also be performed depending on the operation status of the protocol stacks.

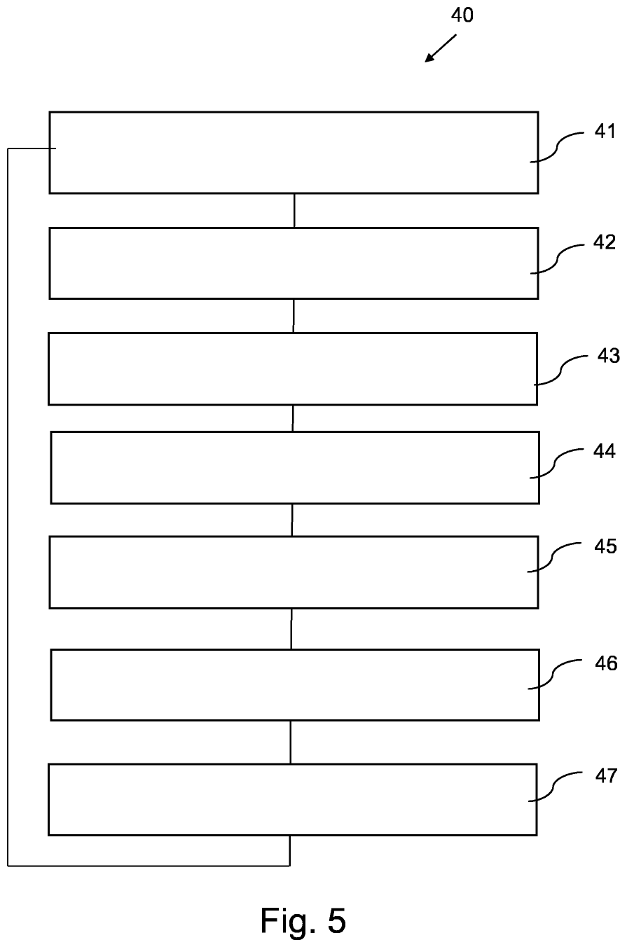

FIG. 5 schematically illustrates, in a flow chart type diagram, an alternative embodiment of a method of controlling of the communication of data packets, according to the present disclosure. In this embodiment, the switching is performed on a flexible schedule.

Steps 41 to 43 and 45 to 46 are the same as step 31 to 33 and 35 to 36 of FIG. 3, while the switching at step 44 and 46 is performed in a different way. According to this embodiment, the switching happens when data packets are received by the second antenna and the protocol stack processing data packet for the first antenna is idling.

Specifically, the indication transmitted from the Rx task to the main task via the control module comprises information representing a priority of the data received via the Rx task. After receiving the indication from the Rx task, the main task will analyze the Bluetooth packet type and decide whether it needs to switch to the Bluetooth stack immediately or not.

If the Zigbee stack is still in the process of Zigbee packet handling, the main task will not switch. If the Zigbee stack is idle, the main task can order the radio controller to switch to the Bluetooth stack immediately.

Then the Bluetooth packets received by the second antenna will be combined with the data packets received by the first antenna. If the Bluetooth stack cannot switch immediately, the second antenna can continuously store the valid Zigbee packets in the data buffer to wait the main task to handle.

The above described fixed or flexible switching schemes can be advantageously combined with the general switching principle described earlier to meet different requirements from different applicants.

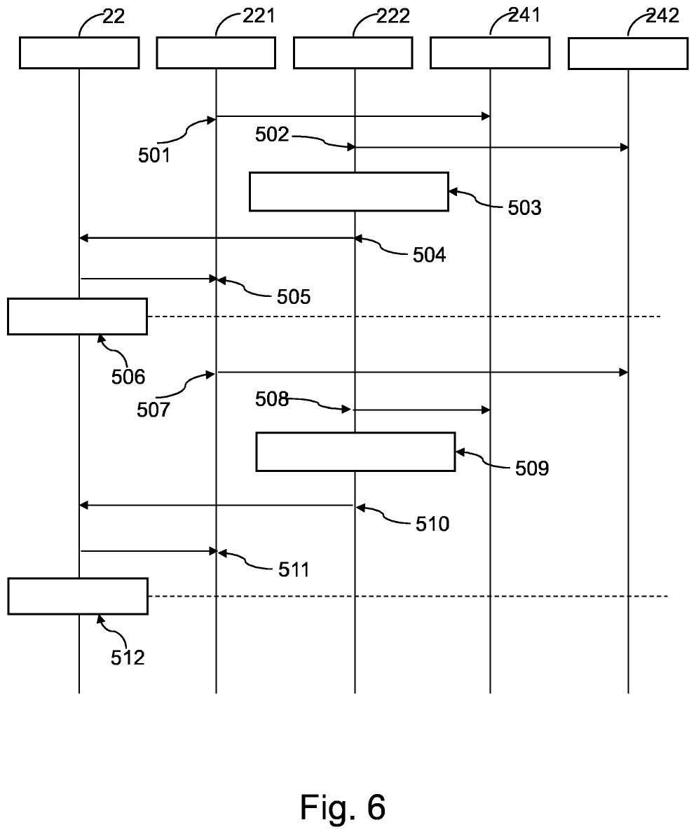

To facilitate better understanding of the present disclosure, the above procedure will be described with reference to a protocol type diagram shown in FIG. 6.

At 501, the main task operates the Zigbee stack, such that the first antenna is operated to communicate Zigbee messages. Simultaneously with 502, the Rx task operates the Bluetooth stack such that the second antenna is operated to detected Bluetooth data.

When Bluetooth data packets are detected and received by the second antenna at 503, the Rx task at 504 transmits an indication to the control module, indicating that Bluetooth data are received. The Rx task also stores the received Bluetooth data packets at the data buffer.

At 505, the control module transmits the indication to the main task. At 506, the control module switches the Zigbee and Bluetooth stacks. It is noted that the switching may happen upon the first time period expires or when it is determined by the main task that it will switch to the Bluetooth stack immediately. The detailed procedure are described above with reference to FIG. 4 and will not be repeated here.

At 507, the main task operates the Bluetooth stack, such that the first antenna is operated to communicate Bluetooth messages. Simultaneously with 508, the Rx task operates the Zigbee stack such that the second antenna is operated to detected Zigbee data.

When Zigbee data packets are detected and received by the second antenna at 509, the Rx task at 510 transmits an indication to the control module, indicating that Zigbee data packets are received. The Rx task also stores the received data packets at the data buffer.

At 511, the control module transmits the indication to the main task. At 512, the control module switches the Zigbee and Bluetooth stacks.

Thereafter the main task operates the Zigbee stack as at 501 and the procedure repeats and continues as described above.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of controlling communication of data packets of a communication device supporting at least a first communication protocol and a second communication protocol, the communication device comprising a control module, a first antenna module and a second antenna module respectively and communicatively connected to the control module, wherein the first antenna module is configured to receive and/or transmit data packets, and the second antenna module is configured to receive data packets only, the method performed by the control module and comprising:
controlling the first antenna module to operate according to the first communication protocol and the second communication protocol alternately by switching the first antenna module between operating according to the first communication protocol and operating according to the second communication protocol, and
controlling the second antenna module to operate according to one of the first and second communication protocols while the first antenna module operates according to the other of the first and second communication protocols.

2. The method according to claim 1, wherein the method comprises:
switching the first antenna module between the first communication protocol and the second communication protocol according to a switching principle.

3. The method according to claim 1, wherein the communication device further comprises a first task scheduler arranged to control data communication by the first antenna module and a second task scheduler arranged to control data receiving by the second antenna module, the method comprises:
transmitting a current status of a protocol stack of the one of the first and second communication protocols currently operated by the first antenna module received from the first task scheduler to the second task scheduler, and
controlling the second task scheduler to operate a protocol stack according to the other one of first and second communication protocols.

4. The method according to claim 1, further comprising:
switching the first antenna module between operating according to the first communication protocol and operating according to the second communication protocol periodically.

5. The method according to claim 1, further comprising:
switching the first antenna module to operate according to the communication protocol of received data packets by the second antenna module if the second antenna module receives data packets while the first antenna module is idle.

6. The method according to claim 1, wherein the switching comprises:
receiving an indication representing a priority of the data packets received by the second antenna module, and
determining to switch the first antenna module to operate according to the communication protocol of received data packets based on the priority of the data packets received by the second antenna module.

7. The method according to claim 5, wherein the communication device comprises a data buffer, wherein data packets received by the second antenna module are stored in the data buffer, wherein the method further comprises, subsequent to the switching step:
retrieving data packets from the data buffer, and
processing the data packets.

8. The method according to claim 2, wherein the data buffer is cleared after the switching step.

9. The method according to claim 1, wherein the first communication protocol comprises ZigBee and the second communication protocol comprises Bluetooth, or vice versa.

10. A communication device configured to have its communication of data packets controlled according to claim 1, the communication device supporting at least a first communication protocol and a second communication protocol, the communication device comprising a control module, a first antenna module and a second antenna module respectively and communicatively connected to the control module, wherein the first antenna module is configured to receive and/or transmit data packets, and the second antenna module is configured to receive data packets only,
wherein the control module is configured to:
control the first antenna module to operate according to the first communication protocol and the second communication protocol alternately by switching the first antenna module between operating according to the first communication protocol and operating according to the second communication protocol, and
control the second antenna module to operate according to one of the first and second communication protocols while the first antenna module operates according to the other of the first and second communication protocols.

11. The communication device according to claim 10, wherein the control module is configured to:
switch the first antenna module between the first communication protocol and the second communication protocol periodically, or
switching the first antenna module to operate according to the communication protocol of received data packets by the second antenna module if the second antenna module receives data packets while the first antenna module is idle.

12. The communication device according to claim 10, wherein the communication device comprises a data buffer, wherein data packets received by the second antenna module are stored in the data buffer, the control module is further configured to:
retrieve data packets from the data buffer, and
process the data packets.

13. The communication device according to claim 10, wherein the first communication protocol comprises ZigBee and the second communication protocol comprises Bluetooth, or vice versa.

14. A non-transitory computer readable medium, comprising instructions which, when executed on at least one processor, cause said at least one processor to carry out the method according to claim 1.
